(19) United States
(12) Patent Application Publication
(10) Pub. No.: US 2013/0226638 A1
(43) Pub. Date: Aug. 29, 2013

(54) SHORTLISTS FOR RESOURCE REQUESTS

(71) Applicants: Jeffrey Thomas Colvard, Wilkinsburg, PA (US); Victoria Leslie, Roseville, CA (US); Brian Cohen, Clayton, CA (US); Darryl Lee Watson, Pleasanton, CA (US); Kevin John Agatone, West Chester, PA (US); Eric Wienke, San Francisco, CA (US)

(72) Inventors: Jeffrey Thomas Colvard, Wilkinsburg, PA (US); Victoria Leslie, Roseville, CA (US); Brian Cohen, Clayton, CA (US); Darryl Lee Watson, Pleasanton, CA (US); Kevin John Agatone, West Chester, PA (US); Eric Wienke, San Francisco, CA (US)

(73) Assignee: Oracle International Corporation, Redwood Shores, CA (US)

(21) Appl. No.: 13/405,452

(22) Filed: Feb. 27, 2012

(51) Int. Cl. G06Q 10/06

(52) U.S. Cl. 705/7.14

(57) ABSTRACT

Various arrangements for maintaining a listing of candidate resources for a resource request are presented. A resource request may be received. A plurality of resource records may be searched using a first set of search criteria to identify a subset of resource records from the plurality of resource records. Each record of the plurality of resource records may indicate qualifications of a corresponding resource. Each record of the plurality of resource records may also correspond to a person. A selection of candidate resource records may be received from the subset of resource records. A listing of candidate resources that indicates each candidate resource selected by the user may be presented to the user. The listing of candidate resources that indicate each candidate resource selected by the user may be linked to the resource request, such that the listing of candidate resources is presented when the resource request is accessed.

### BACKGROUND

In many large enterprises, a person, such as a project manager, may request the services of a second person, such as an employee of the enterprise, that has particular qualifications. Such a request may be referred to as a resource request. A third person, such as a resource manager of the enterprise, may search through records of the enterprise's employees to identify one or more employees who are available and who have as many of the requested qualifications as possible. Of these identified employees, further evaluation may be required by the resource manager, such as by talking to the identified employees, discussing these employees with their current managers, receiving input from other persons, and/or gathering additional information before one of the identified employees may be assigned to fulfill the resource request.

Typically, arrangements that permit resource records of employees to be searched do not permit ways to efficiently organize or manually narrow the search results. As such, a person performing the search, such as a resource manager, may resort to manually noting identified employees on a piece of paper or a separate electronic text document. As such, accessing and/or sharing a listing of identified employees being considered for a resource request may not be efficient.

### SUMMARY

In some embodiments, a method for maintaining a listing of candidate resources for a resource request is presented. The method may include receiving, by a computer system, the resource request. The resource request may specify a plurality of qualifications requested to be held by a resource assigned to fulfill the resource request. The plurality of qualifications may comprise a time period the resource assigned to fulfill the resource request is requested to be available. The method may include searching, by the computer system, a plurality of resource records using a first set of search criteria to identify a subset of resource records from the plurality of resource records. Each record of the plurality of resource records may indicate qualifications of a corresponding resource. Each record of the plurality of resource records may correspond to a person. The method may include presenting, by the computer system, the subset of resource records to a user. The method may include receiving, by the computer system, a selection of a plurality of candidate resource records from the subset of resource records. The method may include presenting, by the computer system, the listing of candidate resources that indicates each candidate resource selected by the user. The method may include linking, by the computer system, the listing of candidate resources that indicate each candidate resource selected by the user to the resource request, such that the listing of candidate resources is presented when the resource request is accessed.

Embodiments of such a method may include one or more of the following: The method may include searching, by the computer system, the plurality of resource records using a second set of search criteria to identify a second subset of resource records. The second set of search criteria may be different from the first set of search criteria. The method may include presenting, by the computer system, the listing of candidate resources such that the listing of candidate resources is presented concurrently with the second subset of resource records. The listing of candidate resources may be displayed concurrently with the subset of resource records. The method may include receiving, by the computer system, a selection of a candidate resource from the listing of candidate resources. The method may include assigning, by the computer system, the candidate resource to the resource request. The method may include receiving, by the computer system, a request for a comparison of the candidate resources listed in the listing of candidate resources. The method may include presenting, by the computer system, the comparison of the candidate resources. The method may include determining, by the computer system, a score for each candidate resource that indicates an amount of compliance with the plurality of qualifications of the resource request. The method may include receiving, by the computer system, a request to access the resource request from a second user. The method may include presenting, by the computer system, the listing of candidate resources as part of the resource request to the second user. The modifications of content of the listing of candidate resources may be saved with requiring additional user input.

In some embodiments, a computer program product residing on a non-transitory processor-readable medium for maintaining a listing of candidate resources for a resource request is presented. The computer program product may comprise processor-readable instructions configured to cause a processor to receive the resource request. The resource request may specify a plurality of qualifications requested to be held by a resource assigned to fulfill the resource request. The plurality of qualifications may comprise a time period the resource assigned to fulfill the resource request is requested to be available. The computer program product may further include processor-readable instructions configured to cause the processor to search a plurality of resource records using a first set of search criteria to identify a subset of resource records from the plurality of resource records. Each record of the plurality of resource records may indicate qualifications of a corresponding resource. Each record of the plurality of resource records may correspond to a person. The computer program product may further include processor-readable instructions configured to cause the processor to present the subset of resource records to a user. The computer program product may further include processor-readable instructions configured to cause the processor to receive a selection of a plurality of candidate resource records from the subset of resource records. The computer program product may further include processor-readable instructions configured to cause the processor to present the listing of candidate resources that indicates each candidate resource selected by the user. The computer program product may further include processor-readable instructions configured to cause the processor to link the listing of candidate resources that indicate each candidate resource selected by the user to the resource request, such that the listing of candidate resources is presented when the resource request is accessed.

Embodiments of such a computer program product may include one or more of the following: The computer program product may further comprise processor-readable instructions configured to cause the processor to search the plurality of resource records using a second set of search criteria to identify a second subset of resource records. The second set of search criteria may be different from the first set of search criteria. The computer program product may further include processor-readable instructions configured to cause the processor to present the listing of candidate resources such that the listing of candidate resources is presented concurrently with the second subset of resource records. The listing of candidate resources may be displayed concurrently with the subset of resource records. The computer program product may further comprise processor-readable instructions configured to cause the processor to receive a selection of a candidate resource from the listing of candidate resources. The computer program product may further include processor-readable instructions configured to cause the processor to assign the candidate resource to the resource request. The computer program product further comprising processor-readable instructions configured to cause the processor to: receive a request for a comparison of the candidate resources listed in the listing of candidate resources. The computer program product may further include processor-readable instructions configured to cause the processor to present the comparison of the candidate resources. The computer program product may further comprise processor-readable instructions configured to cause the processor to determine a score for each candidate resource that indicates an amount of compliance with the plurality of qualifications of the resource request. The computer program product may further comprise processor-readable instructions configured to cause the processor to receive a request to access the resource request from a second user. The computer program product may further include processor-readable instructions configured to cause the processor to present the listing of candidate resources as part of the resource request to the second user. Modifications of content of the listing of candidate resources may be saved with requiring additional user input.

In some embodiments, a system for maintaining a listing of candidate resources for a resource request. The system may include a processor. The system may also include a memory communicatively coupled with and readable by the processor and having stored therein processor-readable instructions. When executed by the processor, the processor-readable instructions may cause the processor to receive the resource request. The resource request may specify a plurality of qualifications requested to be held by a resource assigned to fulfill the resource request. The plurality of qualifications may comprise a time period the resource assigned to fulfill the resource request is requested to be available. When executed by the processor, the processor-readable instructions may cause the processor to search a plurality of resource records using a first set of search criteria to identify a subset of resource records from the plurality of resource records. Each record of the plurality of resource records may indicate qualifications of a corresponding resource. Each record of the plurality of resource records may correspond to a person. When executed by the processor, the processor-readable instructions may cause the processor to present the subset of resource records to a user. When executed by the processor, the processor-readable instructions may cause the processor to receive a selection of a plurality of candidate resource records from the subset of resource records. When executed by the processor, the processor-readable instructions may cause the processor to present the listing of candidate resources that indicates each candidate resource selected by the user. When executed by the processor, the processor-readable instructions may cause the processor to link the listing of candidate resources that indicate each candidate resource selected by the user to the resource request, such that the listing of candidate resources is presented when the resource request is accessed.

Embodiments of such a system may include one or more of the following: When executed by the processor, the processor-readable instructions may cause the processor to search the plurality of resource records using a second set of search criteria to identify a second subset of resource records. The second set of search criteria may be different from the first set of search criteria. When executed by the processor, the processor-readable instructions may cause the processor to present the listing of candidate resources such that the listing of candidate resources is presented concurrently with the second subset of resource records. When executed by the processor, the processor-readable instructions may cause the processor to receive a selection of a candidate resource from the listing of candidate resources. When executed by the processor, the processor-readable instructions may cause the processor to assign the candidate resource to the resource request. When executed by the processor, the processor-readable instructions may cause the processor to receive a request for a comparison of the candidate resources listed in the listing of candidate resources. When executed by the processor, the processor-readable instructions may cause the processor to present the comparison of the candidate resources.

### BRIEF DESCRIPTION OF THE DRAWINGS

A further understanding of the nature and advantages of various embodiments may be realized by reference to the following figures.

FIG. 1 illustrates a block diagram of an embodiment of a system for maintaining a listing of candidate resources to fill a resource request.

FIG. 2 illustrates an embodiment of an interface of a system for maintaining a listing of candidate resources to fill a resource request.

FIG. 3 illustrates another embodiment of an interface of a system for maintaining a listing of candidate resources to fill a resource request.

FIG. 4 illustrates an embodiment of an interface of a listing of candidate resources.

FIG. 5 illustrates an embodiment of an interface of a system for displaying information related to a specific resource.

FIG. 6 illustrates an embodiment of an interface of a system for comparing resources listed on a candidate listing.

FIG. 7 illustrates an embodiment of an interface of a system for presenting candidate listings along with resource requests.

FIG. 8 illustrates an embodiment of a method for maintaining a listing of candidate resources to fill a resource request.

FIGS. 9A and 9B illustrate another embodiment of a method for maintaining a listing of candidate resources to fill a resource request.

FIG. 10 illustrates an embodiment of a computer system.

### DETAILED DESCRIPTION

To facilitate assignment of a resource, such as an employee, to fulfill a resource request, a resource shortlist, also referred to as a candidate listing, may be associated with the resource request that identifies one or more resources that have been identified by a person, such as a resource manager, as worthy of further consideration. A resource request may initially be received from a first person, such as a project manager. The project manager may be requesting a resource, such as a person (e.g., an employee), that has certain qualifications. At least partially based on these qualifications, another person, such as a resource manager, may attempt to identify and assign a resource to fulfill the resource request.

The resource manager may search electronic records of resources to identify a subset of resources that may satisfy the resource request. When the resource manager identifies one or more resources that may satisfy the resource request, the resource manager can specify that the one or more resources be added to a resource shortlist. The resource shortlist may be presented as a list or in some other display format and may identify resources (in this example, employees) that the resource manager has selected as noteworthy. The resource shortlist may be displayed alongside the resource request, thus allowing the resource manager to view and interact with searches related to the resource request and the resource shortlist contemporaneously.

The resource shortlist, as created by the resource manager, may persist with the resource request. As such, as changes are made to the shortlist, the shortlist will be updated and maintained such that when the resource request is accessed, be it by the resource manager or some other user, the resource shortlist will be presented and/or be available for viewing. As changes are made to the resource shortlist, such as resources being added, deleted, or reordered, the changes are automatically saved such that no additional input from a user is required to store the resource shortlist. The resource manager and/or other users may be permitted to navigate away from the resource request and return at a later time; the resource shortlist, as last edited, will be maintained in relation to the resource request. The resource shortlist may facilitate comparisons between the resources indicated on the resource shortlist. When other users access the resource request, the shortlist may be presented for viewing and/or editing. Further, if a search of resources for a resource request is modified, the resource shortlist associated with the resource request may persist. As such, variations on a search may be performed while maintaining the same resource shortlist, allowing selected resources from different searches to be added to the same shortlist.

When further examination of the resources identified on a resource shortlist is desired, the resource shortlist may be expanded from being a persistent graphical element on a portion of a display to being the central feature presented. When the shortlist is expanded, additional information about some or all of the resources listed may be presented. For example, notes made about some or all of the resources by a user such as a resource manager may be presented. Information, such as a score, which may indicate how closely a resource's qualifications match the qualifications identified in the resource request, may be presented. Once a resource has been chosen to fulfill the resource request by the resource manager (or some other user), the resource may be assigned from the resource shortlist to the resource request.

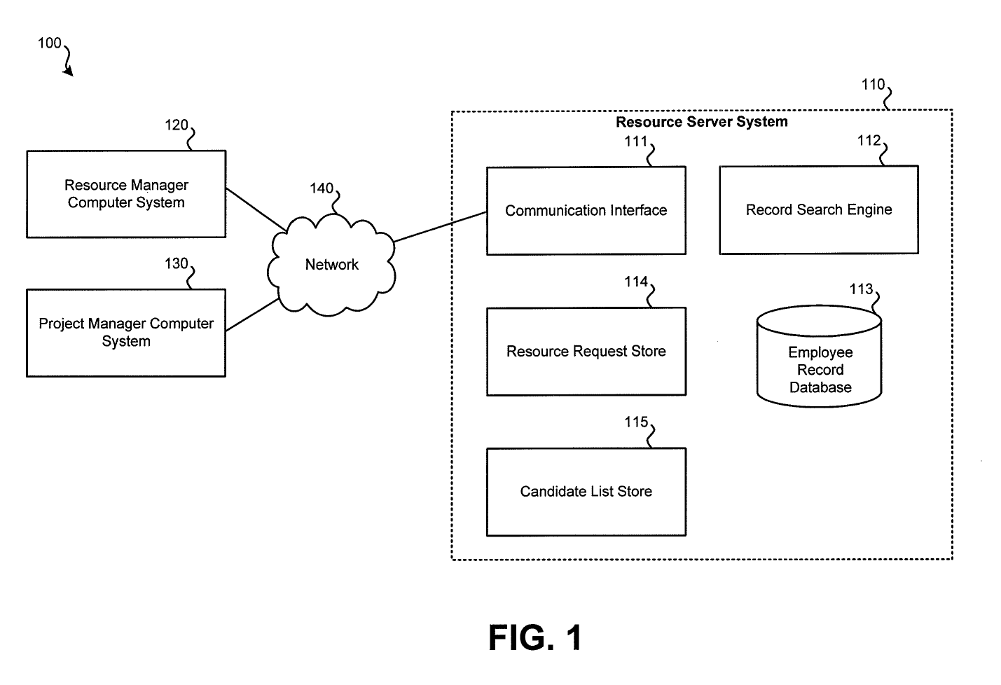

FIG. 1 illustrates a block diagram of an embodiment of a system 100 for maintaining a listing of candidate resources (a resource shortlist) in association with a resource request. System 100 may include: resource server system 110, resource manager computer system 120, project manager computer system 130, and network 140. Resource server system 110 may include various components. Such components may include: communication interface 111, record search engine 112, employee record database 113, resource request store 114, and candidate list store 115.

Project manager computer system 130 may represent a computer system or other computerized device operated by a project manager (or some other type of user that is submitting a resource request). Project manager computer system 130 may be used to create and submit a resource request. Such a resource request may be a request for the services of a person, such as an employee of an enterprise. While the embodiments described herein are focused on resource requests for the services of a person (also generally referred to as an employee), it should be understood that similar principles may be applied to other forms of resources, such as physical equipment (e.g., a forklift), computing resources (e.g., processing time on a server), and physical space (e.g., a conference room).

A project manager, or some other form of system user, may create a resource request using project manager computer system 130. The resource request may specify various qualifications that the resource is required and/or desired to possess. For instance, the resource request may specify a time range during which the resource is requested to be available. The resource request may also specify skills, such as computer programming languages, in which the resource is expected to be proficient. Other qualifications may include: a physical location, a job title, language skills, degrees, etc. Based on the enterprise on whose behalf the project manager is procuring the resource, the types of qualifications requested may vary.

As an example of when a user, such as a project manager, may need to request an employee through a resource request, consider a large engineering company. Such a company may have thousands of employees scattered across many projects, each with varying and changing needs. When a project manager needs a person to perform a particular task, such as program code in a particular computing language, rather than a project manager calling around to other project managers or directly to employees of the organization to determine who has the skills and availability for such work, the project manager may submit a resource request stating the qualifications required and/or desired, to another party, referred to as a resource manager. The resource manager, or some other user, may be responsible for finding an appropriate employee to fill the resource request.

The resource request submitted by a project manager via project manager computer system 130 may be received by resource server system 110 via network 140. Network 140 may represent one or more public and/or private networks. A public network may include the Internet. A private network may include a corporate intranet.

Resource manager computer system 120 may represent a computer system operated by a resource manager or some other user tasked with matching resources to resource requests. A resource manager may be responsible for matching a resource to the resource request received by resource server system 110 from project manager computer system 130. As such, based on the qualifications desired and/or required by the resource request received from project manager computer system 130, a resource manager may search the resources of the enterprise to find one or more resources that match, or match as closely as possible, the requested qualifications. Therefore, the resource manager that is searching the enterprise's available resources using resource server system 110 via network 140 may identify some number of candidate resources that need further investigation before one is assigned to fulfill the resource request.

A simple search to find matches between the qualifications of the resource request and an enterprise's resources may be insufficient. The resource manager (or some other user) may need to discuss various candidate resources with other persons, such as other resource managers and/or other project managers, before the resource is assigned to fulfill the resource request. As a simple example, if multiple candidate resources are identified as possibly being sufficient to satisfy the resource request, the resource manager may want to contact each candidate resource to see who is most interested in filling the resource request.

While resource manager computer system 120 and project manager computer system 130 are illustrated in FIG. 1 as separate computer systems, it should be understood that the same computer system may be used by a project manager and a resource manager. Further, it is also possible that in some embodiments the same person who is acting as a project manager and requesting a resource may also be acting as a resource manager who is assigning a resource to fulfill the resource request. Further, while a single resource manager computer system and a single project manager computer system are illustrated in system 100 of FIG. 1, it should be understood this is for illustration purposes only. In other embodiments of system 100, multiple project manager computer systems (associated with multiple project managers) may be present. Similarly, multiple resource manager computer systems (associated with multiple resource managers) may be present in other embodiments of system 100. Resource server system 110 may be handling many resource requests concurrently.

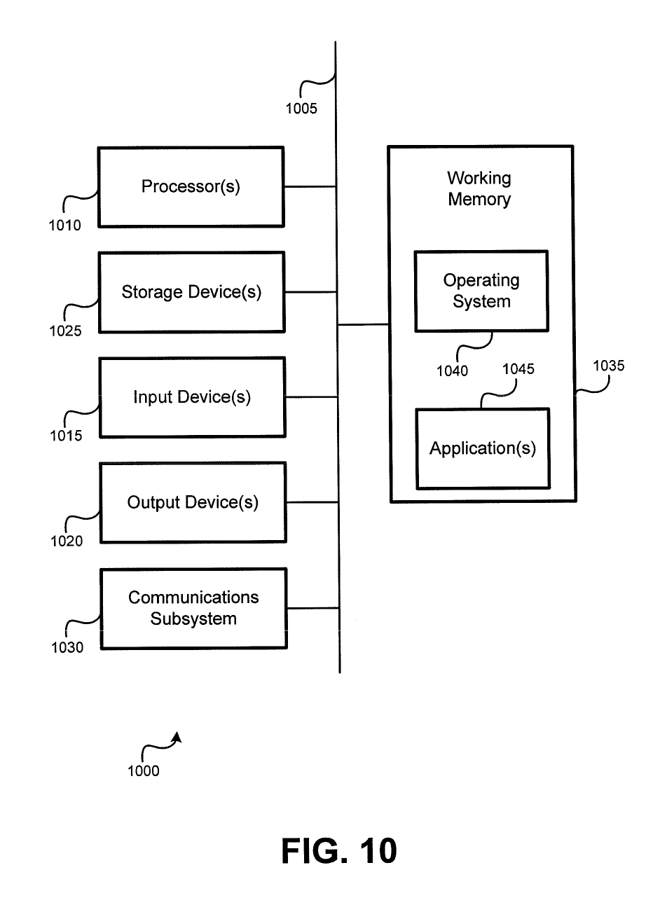

Resource server system 110 may include one or more computer systems. The one or more computer systems of resource server system 110 may be computer systems as described in relation to computer system 1000 of FIG. 10. Resource server system 110 may serve to receive requests from project manager computer system 130, present such resource requests to a resource manager (via resource manager computer system 120), perform searches on behalf of the resource manager (via resource manager computer system 120), and/or present search results to the resource manager (via resource manager computer system 120). While resource server system 110 is illustrated as a separate computer system from resource manager computer system 120 and project manager computer system 130, it should be understood that the functions of one or more of these computer systems may be performed by a single computer system.

As part of resource server system 110, communication interface 111 may be present. Communication interface 111 may serve to receive and transmit information with project manager computer system 130 and resource manager computer system 120. As such, communication interface 111 may receive resource requests from project manager computer system 130. Further, requests for searches may be received from resource manager computer system 120 via communication interface 111. More generally, information exchanged between external computer systems and resource server system 110 may occur via communication interface 111.

Employee record database 113 may store records corresponding to some or all of an enterprise's employees. In the illustrated embodiment, employees are the resources. In other embodiments, employee record database 113 may be augmented or replaced with records for other types of resources. In the illustrated embodiment, each record of employee record database 113 may contain information (e.g., qualifications) about a specific employee. Such information may include information such as: the employee's name, location, education, skills, availability, contact information, picture, and/or job title.

Resource request store 114 may serve to store resource requests received from project manager computer system 130. An open resource request, that is a resource request that has not yet had a resource assigned to it, may be stored by resource request store 114 and may be made available to a resource manager such that the resource manager can assign a resource to the resource request. At any given time, resource request store 114 may contain none, one, or more than one resource requests received from the same or different project managers.

In order to fulfill a resource request stored by resource request store 114, a resource manager may conduct a search of employee record database 113 for an appropriate employee (resource). To do this, record search engine 112 may be used. Record search engine 112 may be configured to search employee record database 113 using some or all of the qualifications specified in the resource request and/or as modified by the resource manager. For example, an employee may not be able to be found within employee record database 113 that meets each of the qualifications present in the resource request. As such, the resource manager may have to modify the search to find an employee that best fits the qualifications in the resource request.

The process of matching an employee (the resource) to a resource request may be a time-consuming endeavor for a resource manager. After conducting an initial search and obtaining a subset of employees that were returned via the search, the resource manager may be able to identify some number of candidate employees that might be sufficient to satisfy the resource request. The resource manager can create a resource shortlist, also referred to as a candidate list, using selections for the subset of employees. Candidate list store 115 may store a listing of candidates associated with the resource request. The resource manager may be permitted to add and subtract indications of employees from this candidate list. The candidate list stored by candidate list store 115 may remain associated with the resource request. As such, while the resource request is open, the candidate list, as selected by the resource manager, may remain associated with the resource request. Therefore, when the resource request is accessed by the resource manager, or by some other user, the candidate list may be presented. As an example of another user that may wish to view the candidate list, during the process of matching a resource to the resource request, the project manager may access his previously submitted resource request via project manager computer system 130. When accessing the resource request, the project manager may be able to view the candidate list associated with the resource request. As such, the project manager may be permitted to learn of the various employees that the resource manager is considering assigning to fill the resource request.

Candidate list store 115 may automatically update as a candidate list is modified by a resource manager, or some other user. Therefore, whenever a resource is added, subtracted, or otherwise modified on a candidate list, the modified candidate list may be saved and maintained in relation to the resource request. If the resource manager, or some other user, navigates away from the resource request, the candidate list linked with the resource request will be presented when the resource request is reloaded. Candidate list store 115 may be storing multiple candidate lists, each associated with a particular resource request.

While communication interface 111, record search engine 112, employee record database 113, resource request store 114, and candidate list store 115 of resource server system 110 are illustrated as discrete components, it should be understood that such components may be combined into fewer components or divided into additional components. For example, employee record database 113 may include multiple databases. Further one or more of the various components of resource server system 110 may be external. For example, employee record database 113 may be remotely accessible.

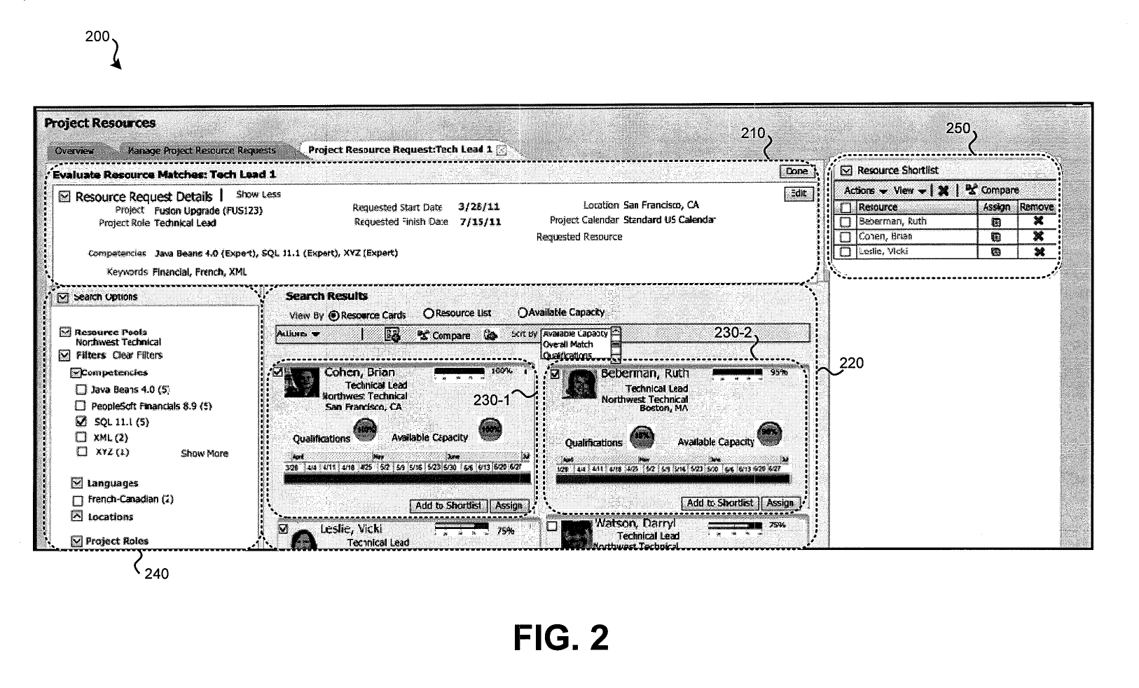

FIGS. 2 through 7 illustrate various embodiments of candidate listings (also referred to as resource shortlists). It should be understood that such embodiments of candidate listings are not intended to be limiting. Rather, the embodiments of FIGS. 2 through 7 are intended to serve as examples of how such candidate listings may function and/or appear. The candidate lists of FIGS. 2 through 7 may be stored using candidate list store 115 and linked with corresponding resource requests, stored by resource request store 114. Resource request store 114 and candidate list store 115 may be stored using non-transitory computer-readable storage mediums. As such, the interfaces of FIGS. 2 through 7 may be created using system 100 of FIG. 1 or some other system for maintaining a listing of candidate resources to fill a resource request. FIG. 2 illustrates an embodiment of an interface 200 of a system for maintaining a candidate listing to fill a resource request.

Interface 200 is directed to project resources as may be viewed by a resource manager. Resource request details 210 provides information about a resource request. This resource request may have been received from another user, such as a project manager. The resource request details 210 may indicate the various qualifications required and/or desired by the user that submitted the resource request. In the illustrated embodiment, resource request details 210 indicate a project name, a project role, a requested start date, a requested finish date, a location, and a project calendar. These details may indicate which project the resource is needed to work on, the resource's role on the project, the start and finish dates of when the resource's services are required, the physical location, and the type of calendar being used, respectively. Further, various competencies are listed as qualifications within resource request details 210. In the illustrated example of resource request details 210, JAVA BEANS 4,0, SQL 11.1, and XYZ are listed as required and/or desired competencies. For each of these competencies, a level of competency may be indicated. In the illustrated example of resource request details 210, a competency level of expert is requested and/or required for each of the example competencies.

Using resource request details 210, a resource manager may coordinate a search. Search results 220 indicate some or all of the resources that were returned in a search performed using at least some of resource request details 210. Within search results 220, at least four records associated with four employees are present. Record 230-1 corresponds to a resource (employee) named Brian Cohen. Record 230-2 corresponds to a resource named Ruth Beberman. Within records 230, information about the corresponding employee and how the employee matches qualifications of the conducted search may be provided. For example, referring to records 230, the employee's name, the employee's title, the employee's resource pool (which may refer to an organizational structure used to organize resources in a meaningful way), and physical location are provided. Additionally, a timeline is provided that indicates the employee's availability over the time period identified (such as the first five weeks of when a resource is needed) in resource request details 210. How closely the employee's qualifications match the qualifications searched for may be indicated as a percentage. Further, the employee's availability, as compared to the requested time period indicated in the search, may be presented as a percentage. An overall score of the employee may be calculated using the employee's availability and other matching qualifications.

As illustrated in interface 200, at least four records 230 at least partially satisfy the search performed using at least some of the resource request details 210. Filter terms 240 may allow a resource manager, or other user performing the search, to filter the results of a search. The search may be at least loosely based on the qualifications requested as part of the resource request. For example, while resource request details 210 may indicate several qualifications desired or required by the resource request, it may not be possible to find a particular resource (employee) that has each of these qualifications. As such, the search, via filter terms 240, may be broadened or otherwise modified to increase (or decrease or change) the search results presented in search results 220. As filter terms 240 are modified, the records presented in search results 220 may change. An edit button (or similar interface) of resource request details 210 may be used to edit the search terms, while filter terms 240 may be used to filter the results returned by the search.

Displayed along with resource request details 210 and search results 220 may be resource shortlist 250 (also referred to as a candidate list). A resource manager may add or remove resources to and from resource shortlist 250 that are being considered for use in fulfilling the resource request. As such, resource shortlist 250 provides a display element where the resource manager can record and view resources that are considered noteworthy. Referring to search results 220, a record, such as record 230-1, may be added to resource shortlist 250 through use of the “add to shortlist” button present on record 230-1.

Resource shortlist 250 may remain associated with the resource request indicated by resource request details 210. As such, if the resource request is accessed at a later time, whether by the resource manager or some other user, resource shortlist 250 may also be displayed (along with indications of the resources listed therein). Resource shortlist 250 may automatically be saved as displayed by interface 200. As such, whenever a resource is added to or removed from resource shortlist 250, resource shortlist 250 may be stored in its current state.

Resource shortlist 250 may be especially useful for a resource manager that is managing multiple resource requests. As the resource manager narrows down search results to identify various candidate resources to fill the resource request, these candidate resources may be added to the resource shortlist 250. The selection of a resource from these candidate resources to fulfill the resource request may stall at this stage for several reasons. For example, the resource manager may want to contact each of the candidate resources, contact the requesting project manager, or perform some other task that requires the resource manager's attention. Whichever the case, when the resource request is again addressed, resource shortlist 250, which indicates resources added by the resource manager, may be preserved with the resource request.

Resource shortlist 250 may permit a user to rearrange an ordering of indications of records present on resource shortlist 250. For example, a resource manager, or other user, may be permitted to reorder indications of records within resource shortlist 250 to indicate a preference for particular candidate records on the resource shortlist: the top listed record may be the resource manager's current first choice.

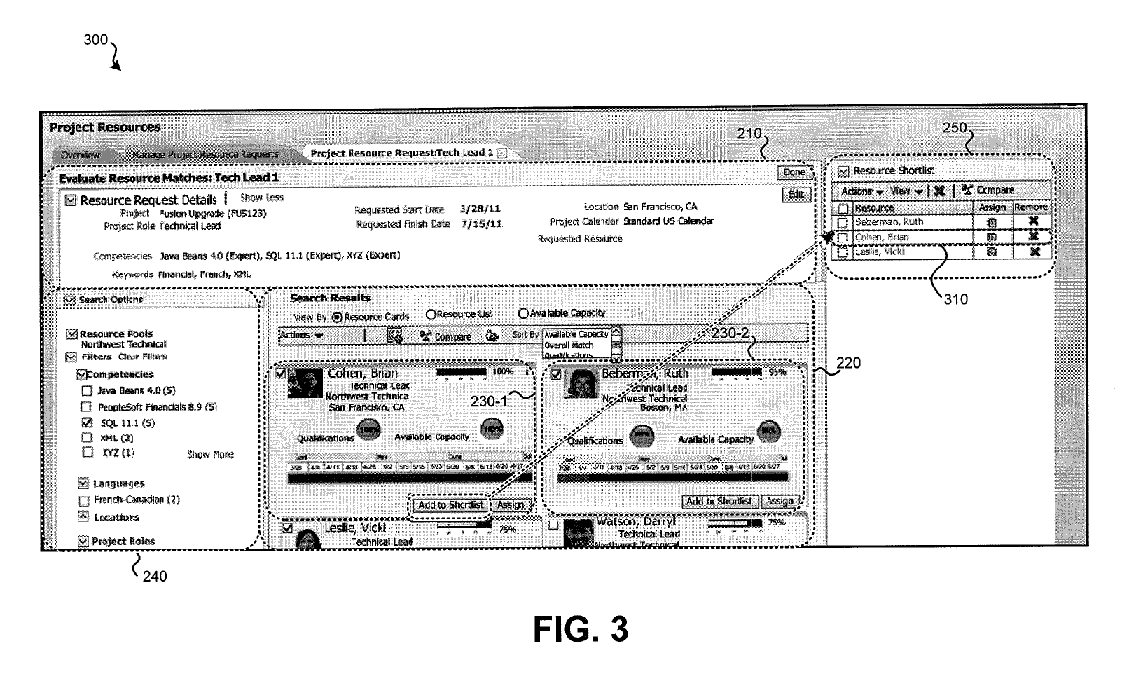

FIG. 3 illustrates another embodiment of an interface 300 of a system for maintaining a listing of candidate resources to fulfill a resource request. As illustrated by the (imaginary) dotted arrow of interface 300, when a user, such as a resource manager, selects an “Add to Shortlist” (or equivalent) button of a record, such as record 230-1, an indication of the record is added to resource shortlist 250. An indication of record 230-1 (and its corresponding resource) is listed on resource shortlist 250, until removed. For example, if the resource manager modifies filter terms 240, the filtering of the results from the search changes and thus the search results displayed in search results 220 may change. However, resource shortlist 250, unless modified by the resource manager, would remain static. Therefore, a search may be modified and return different results that may be added to candidate resources on the resource shortlist selected from another search. This may be especially useful if an available resource having all the requested or desired qualifications of the resource request is not available. A resource shortlist of available resources that have some of the qualifications may be created by performing multiple searches and adding a number of candidate resources from each search to resource shortlist 250.

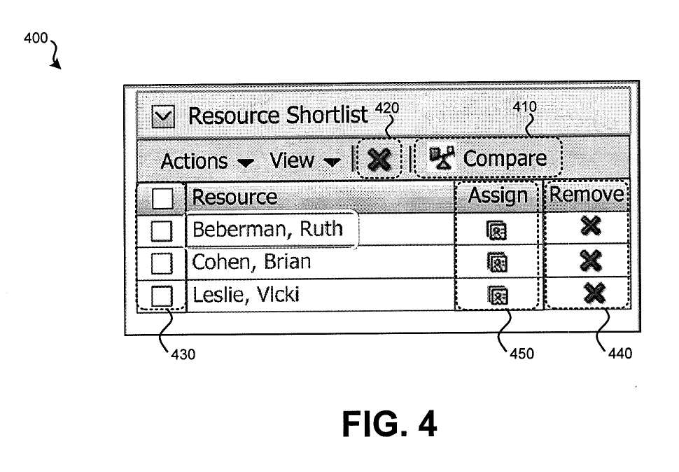

FIG. 4 illustrates an embodiment of a resource shortlist 400. Resource shortlist 400 may represent the resource shortlist of FIGS. 2 and 3. Resource shortlist 400 may include various components, such as: comparison selector 410, group remove selector 420, resource selectors 430, remove selectors 440, and assignment selectors 450. The three records listed, for Ruth Beberman, Brian Cohen, and Vicki Leslie may have been previously added to resource shortlist 400 by a resource manager. Comparison selector 410 may permit a resource manager to compare multiple records. The resource manager may use resource selectors 430 to select multiple records of candidate resources for the comparison. Group remove selector 420 may permit a resource manager to remove candidate resources selected using resource selectors 430 from resource shortlist 400. Remove selectors 440 may permit individual resources to be removed from resource shortlist 400. Assignment selectors 450 may permit a resource to be assigned to fulfill a resource request. Embodiments of resource shortlist 400 may contain fewer or additional components. The illustrated embodiment of resource shortlist 400 is for example purposes only; other embodiments of resource shortlist 400 may be visually arranged differently.

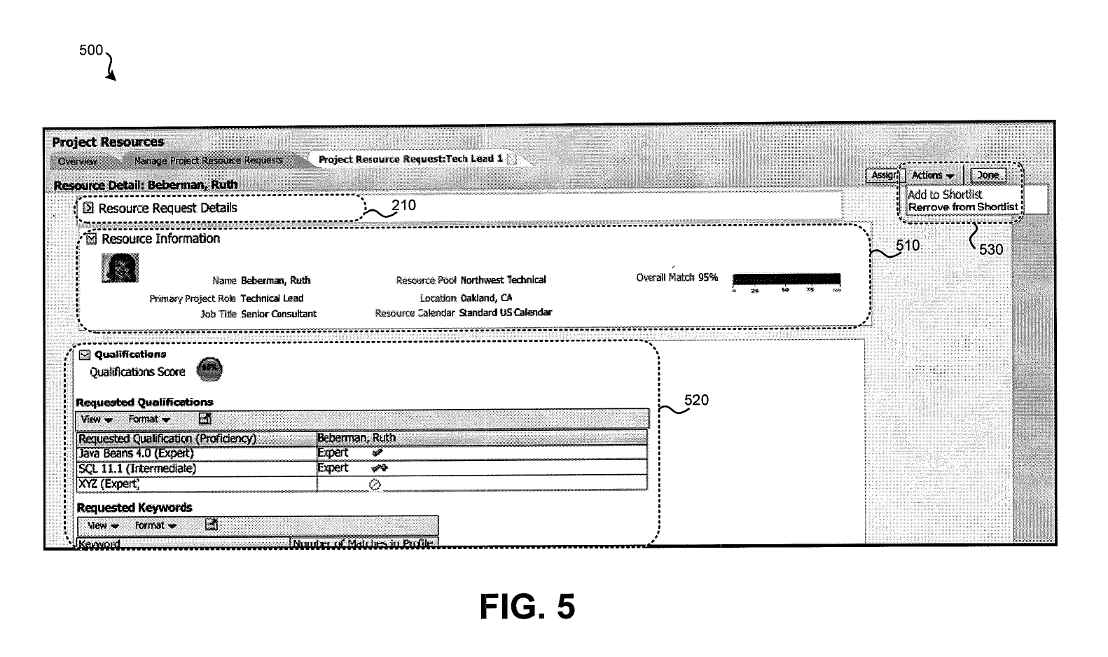

FIG. 5 illustrates an embodiment of an interface 500 of a system for displaying information related to a specific resource. Interface 500 may be displayed when a user, such as a resource manager, has selected a record, such as record 230-2 of FIG. 2 from search results 220 or from resource shortlist 250. By selecting a particular record, additional information about the resource may be viewed. While viewing such details of the record, resource request details 210 may be possible to be viewed. In the illustrated embodiment of interface 500, such resource request details 210 are minimized. Resource information 510 may provide information from the record that indicates information about the resource, such as: the resource's name, the resource's title, the resource's primary role, the resource pool, the location, the resource calendar, and the overall match between the resource and the resource request. Resource information 510 is directed to information specific to when the resource is a person; if the resource is some other form of entity, different information about the resource may be provided in resource information 510. Qualifications 520 may provide a comparison between the qualifications of the resource in the qualifications requested as part of the resource request. A score, or other number, may be provided that indicates how closely the resource's qualifications match the qualifications of the resource request.

While viewing interface 500, it may be possible to add an indication of the presented resource to a resource shortlist via resource shortlist interface 530. Resource shortlist interface 530 may also permit removal of indication of the presented resource from a resource shortlist. In some embodiments, the resource shortlist may be presented as part of interface 500. In addition to a display of the shortlist for the current request, in interface 500 a listing of all of the project requests where the resource is presented listed on the requests' shortlists may be indicated. As such, if a resource is currently listed on multiple shortlists, an indication of each of the resource requests associated with the multiple shortlists may be indicated in interface 500. Resource shortlist interface 530 permits a user, such as a resource manager, to easily add and/or remove a resource to or from a resource shortlist while viewing the details associated with the resource.

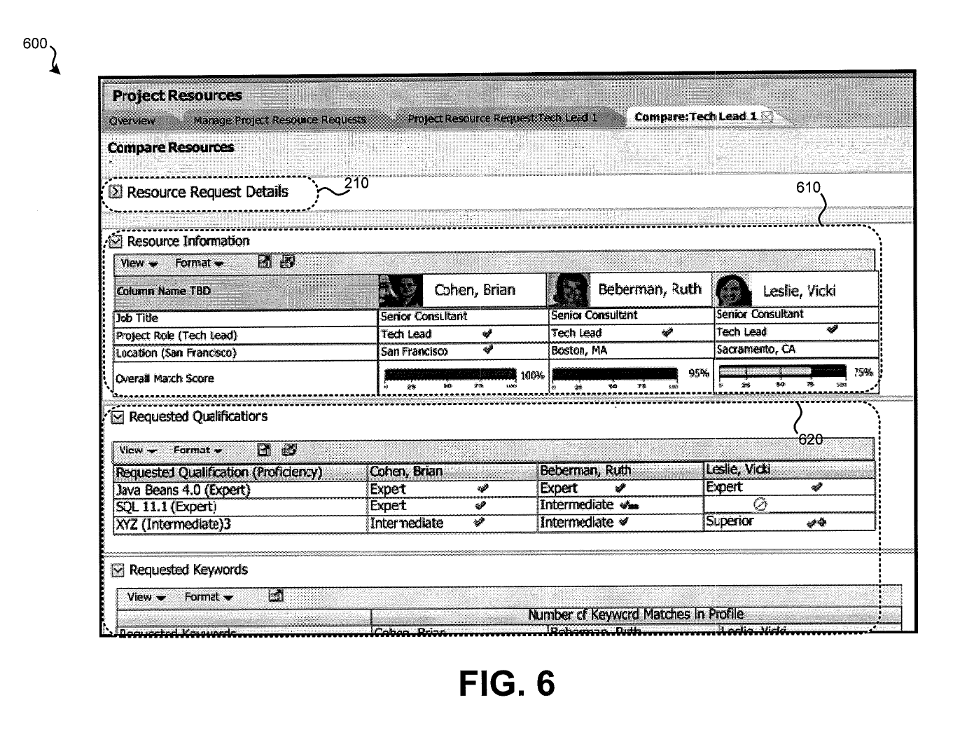

FIG. 6 illustrates an embodiment of an interface 600 of a system for comparing resources listed on a candidate listing. Referring to resource shortlist 400 of FIG. 4, a user is permitted to select one or more resources from resource shortlist 400 for comparison. An example of such a comparison is illustrated in interface 600. In interface 600, three records are being compared. These records may have been selected using a resource shortlist such as resource shortlist 400 of FIG. 4. Resource information 610 provides a comparison of the three records. Requested qualifications 620 provides a comparison between each resource of the records being compared regarding the qualifications requested in the resource request.

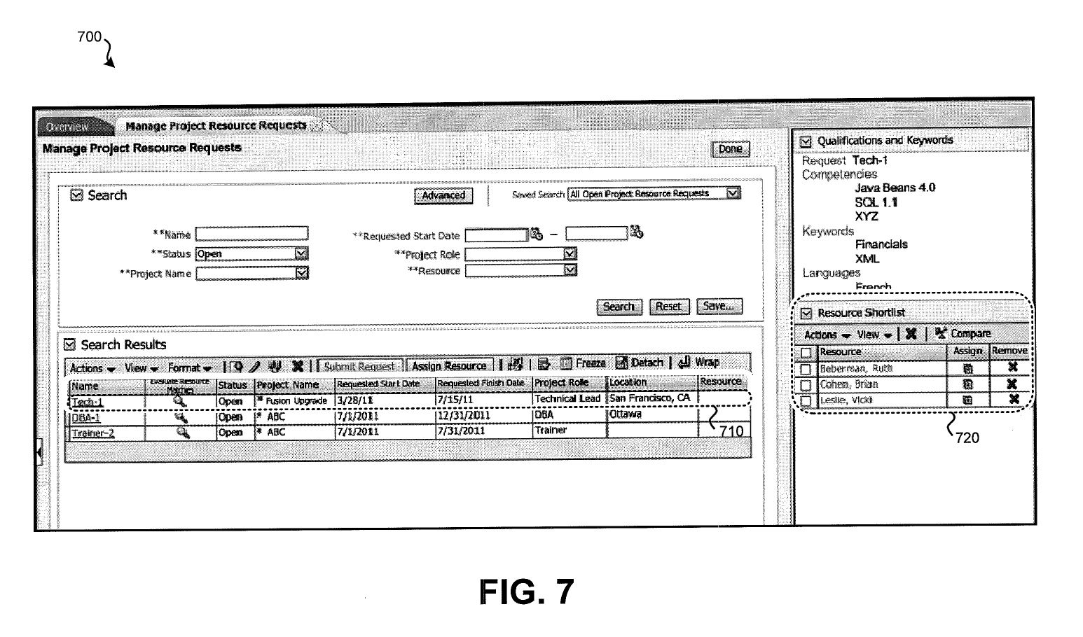

As previously discussed, a resource shortlist persists with the resource request. As such, other users, besides the user (e.g., the resource manager) that initially added indications of candidate resources to the resource shortlist, may view the resource shortlist when the corresponding resource request is accessed. FIG. 7 illustrates an embodiment of an interface 700 of a system for presenting a resource request along with the corresponding resource shortlist. Using interface 700, a user may select a resource request (possibly from among multiple resource requests) to view details about the resource request and an associated resource shortlist. For example, the user may select resource request 710. When resource request 710 is selected, resource shortlist 720 may be presented.

The candidate records indicated on resource shortlist 720 may have been added by the same user that selected resource request 710 via the interface 700 or by some other user.

If by the same user, resource shortlist 720 may serve as a reminder as to the candidate resources the user is considering for assigning to the resource request. If the user interacting with interface 700 is a project manager, the resource shortlist 720 may permit the project manager to learn which resources are being considered for assignment to fulfill the resource request. Depending on a permission level of the user, only certain users may be permitted to edit resource shortlist 720. For example, only resource managers may be permitted to modify a resource shortlist; project managers may be permitted to only view a resource shortlist.

Since a resource shortlist, such as resource shortlist 720, is associated with a particular resource request, selection of a different resource request may result in the presentation of a resource shortlist having different resources indicated. When a resource request is selected, along with the resource shortlist, a summary of the requested qualifications may be presented.

Resource shortlist 720 may contain the same features as resource shortlist 400 of FIG. 4. As such, a user with the proper permissions may be able to assign a resource to fulfill (close) a resource request, remove an indication of a resource from the resource shortlist, and/or perform a comparison of some or all of the resources indicated on the resource shortlist.

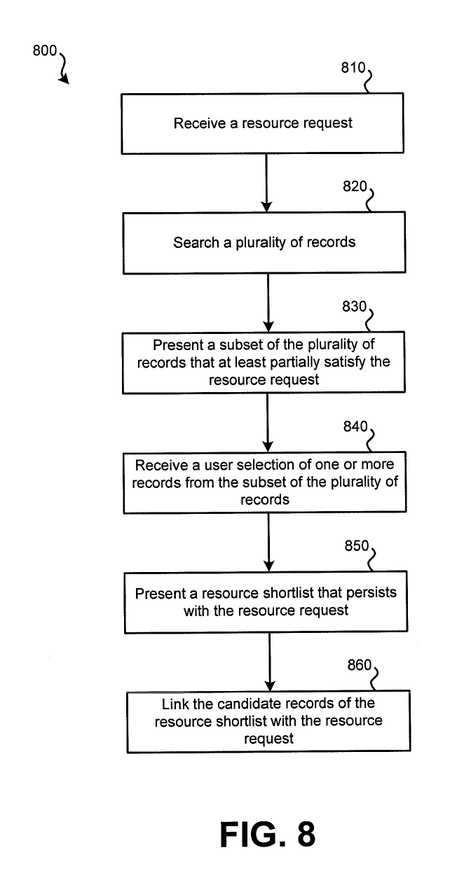

The interfaces and systems of FIGS. 1 through 7 may be used to perform various methods. FIG. 8 illustrates an embodiment of a method 800 for maintaining a listing of candidate resources for a resource request. Method 800 may be performed using system 100 of FIG. 1 or some other system configured for maintaining a listing of candidate resources to fulfill a resource request. Performing method 800 may involve use of one or more computer systems, such as computer system 1000 of FIG. 10. Means for performing method 800 involve computer systems and other various computerized devices. Method 800 may involve use of one or more embodiments of the interfaces presented in FIGS. 2 through 7.

At step 810, a resource request may be received. Such a resource request may be received from a project manager or some other type of user. The resource request may specify various qualifications that are desired and/or required of the resource. Such qualifications may include a time period over which the resource is requested to be available. The resource requested may be a person, such as an employee of an enterprise (e.g., a corporation, a non-profit organization, a company). Other types of resources may also be requested via a resource request, such as equipment, a location, computing resources, etc.

The resource request may be received locally by the computer system receiving the resource request or may be received from a remote computer system, such as a project manager computer system. The resource request, until a resource has been assigned to fulfill the resource request, may be open. At a given time, multiple open resource requests from one or more than one users may exist.

At step 820, a plurality of records may be searched. Each of the records searched may correspond to a resource that might be used to fulfill the resource request. For example, each of the plurality of records may correspond to an employee of an enterprise. The plurality of records may be searched using the qualifications specified in the resource request. The search performed at step 820 may be modified to be narrower or broader than the qualifications specified in the resource request. For example, certain qualifications specified in the resource request may be omitted from the search in order to return a higher number of results. The search may be modified by a different user than the user that submitted the resource request. For example, the search may be modified by a resource manager. The search of the plurality of records at step 820 may be conducted multiple times using different search terms that are based on the qualifications of the resource request. Different searches may return different results from the plurality of records.

At step 830, a subset of the plurality of records that at least partially satisfy the search request may be presented in response to the search performed at step 820. The subset of the plurality of records may be presented in an order that corresponds to how closely each record of the subset matches the search terms (qualifications) used for the search. As illustrated in interface 200 of FIG. 2, records associated with resources may be returned. Some or all information present within these records may be presented as part of the search results. Referring to FIG. 2, an employee's name, title, and location are presented as part of the search results.

From the subset of the plurality of records presented at step 830, a user may be able to add one or more of the records to a resource shortlist. At step 840, a user selection of one or more records from the subset is received. When a record is selected for addition to the resource shortlist, an indication of the record may appear on the resource shortlist. The resource shortlist may be displayed concurrently with the search results (the subset). If multiple resources are indicated on the resource shortlist, the ordering of resources on the resource shortlist may be based according to: alphabetical order, order in which added to the resource shortlist, or as set by the user. Other orderings are also possible. Receiving the user selection of a record may involve a user clicking a button that indicates “Add to Shortlist.” Other possible forms of user selection are also possible.

At step 850, while the resource request is being presented to a user, the resource shortlist may also be presented. For example, as long as the resource request is open, the resource shortlist may be presented when the resource request is being accessed by a user. The resource shortlist may be presented to some or all users that access the resource request. For example, the resource shortlist may be presented to the user that added indications of resources to the resource shortlist and to other users that have not added resources to the resource shortlist. Having the resource shortlist persist with the resource request results in the resource shortlist being available at a later time when the resource request is accessed. Changes made to the resource shortlist, whether by the user that added an indication of a resource to the resource shortlist or some other user, may be saved as part of the resource shortlist for the resource request without further user input. As such, multiple users may edit a resource shortlist. The resource shortlist presented at step 850 may be presented when the resource request is accessed, search results pertaining to the resource request are presented, a comparison between resources listed on the resource shortlist is being presented, and/or when the details of a record accessed in response to a search for the resource request are being viewed.

At step 860, indications of the records added to the resource shortlist may be linked with the resource request. As such, the resource shortlist, as presented at step 850, may be recalled when the resource request is recalled from storage. The ordering of resources on the resource shortlist may be maintained as ordered by a user. If multiple resource requests are being stored, each of these resource requests may be associated with its own resource shortlist.

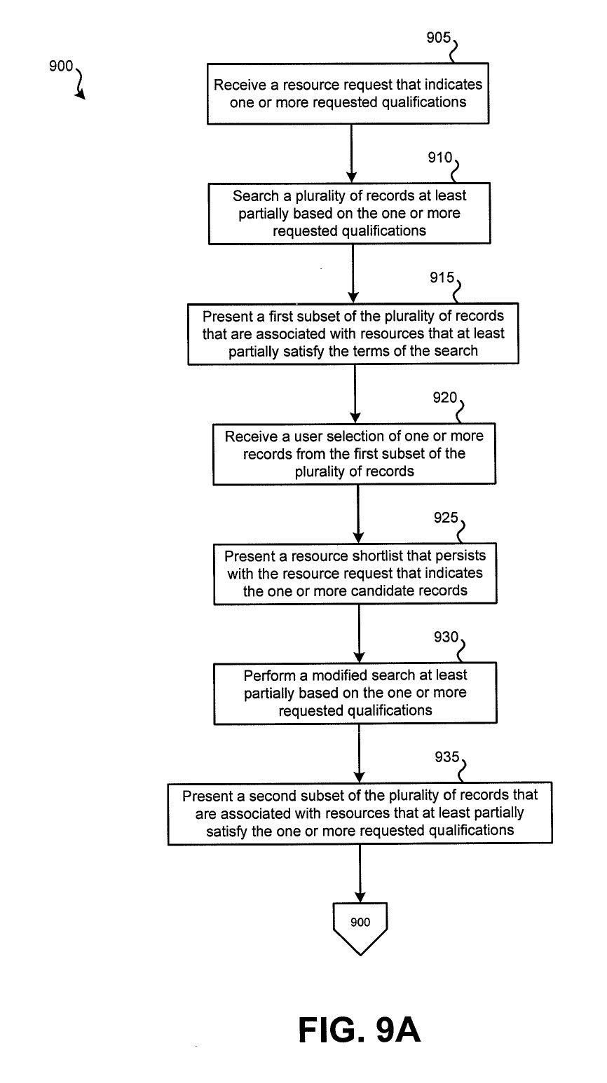

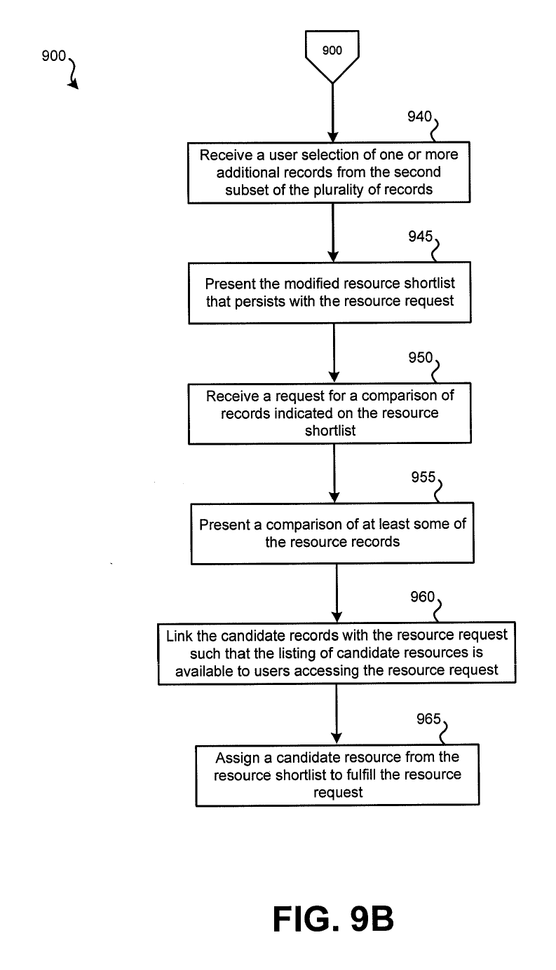

FIGS. 9A and 9B illustrate another embodiment of a method 900 for maintaining a listing of candidate resources to fill a resource request. Method 900 may be performed using system 100 of FIG. 1 or some other system configured for maintaining a listing of candidate resources to fill a resource request. Performing method 900 may involve use of one or more computer systems, such as computer system 1000 of FIG. 10. Means for performing method 900 involve computer systems and other various computerized devices. Method 900 may involve use of one or more embodiments of the interfaces presented in FIGS. 2 through 7. Method 900 may represent an embodiment of method 800 of FIG. 8.

Referring first to FIG. 9A, at step 905, a resource request may be received. Such a resource request may be received from a project manager or some other user. The resource request may specify various qualifications that are desired and/or required of the resource. Such qualifications may include a time period over which the resource is to be available. Other qualifications may include: a physical location, skills, job title, years of experience, etc. The resource requested may be a person, such as an employee of an enterprise. Other types of resources may also be requested, such as equipment, a location, computing resources etc. The resource request may be received locally by the computer system receiving the resource request or may be received from a remote computer system (via a network), such as a project manager computer system. The resource request, until a resource has been assigned to fulfill the resource request, may be considered open. At a given time, multiple open resource requests from one or more than one users may exist.

At step 910, a plurality of records may be searched. Each of the records searched may correspond to a resource that might be used to fulfill the resource request. For example, each of the plurality of records may correspond to an employee of an enterprise. The plurality of records may be searched using some or all of the qualifications specified in the resource request. The search performed at step 910 may be modified to be narrower or broader than the resource request. For example, certain qualifications specified in the resource request may be omitted from the search in order to return a higher number of results. The search may be coordinated by a different user than the user that submitted the resource request. For example, the search may be modified by a resource manager. The search of the plurality of records at step 910 may be conducted multiple times using different search terms that are based on the qualifications of the resource request. Different searches may return different results from the plurality of records.

At step 915, a subset of the plurality of records that at least partially satisfy the search request may be presented in response to the search performed at step 910. The subset of the plurality of records may be presented in an order that corresponds to how closely each record of the subset matches the search terms (qualifications) used for the search. As illustrated in interface 200 of FIG. 2, records associated with resources may be returned. Some or all information present within these records may be presented as part of the search results. Referring to FIG. 2, an employee's name, title, and location are presented as part of the search results.

From the subset of the plurality of records presented at step 915, a user may be able to add one or more of the records to a resource shortlist. At step 920, a user selection of one or more records from the subset is received. When a record is selected for addition to the resource shortlist, an indication of the record may appear on the resource shortlist, such as a name of the resource. In the case of resources being persons, the name of the person may appear in the resource shortlist. The resource shortlist may be displayed concurrently with the search results (the subset). If multiple resources are indicated on the resource shortlist, the ordering of resources on the resource shortlist may be based according to: alphabetical order, order in which added to the resource shortlist, or as set by the user. Other orderings are also possible. Receiving the user selection of a record may involve a user clicking a button that indicates “Add to Shortlist.” Other possible forms of user selection are also possible.

At step 925, while the resource request is being presented to a user, the resource shortlist may also be presented. For example, at least as long as the resource request is open, the resource shortlist may be presented when the resource request is being accessed by the user. The resource shortlist may be presented to some or all users that access the resource request. For example, the resource shortlist may be presented to the user that added indications of one or more resources to the resource shortlist and to other users that have not modified the resource shortlist. Having the resource shortlist persist with the resource request results in the resource shortlist being available at other times when the resource request is again accessed. Changes made to the resource shortlist, whether by the user that added indications of one or more resources to the resource shortlist or some other user, may be saved as part of the resource shortlist when the changes were made. The resource shortlist presented at step 925 may be presented when the resource request is accessed, search results pertaining to the resource request are presented, a comparison between resources listed on the resource shortlist is being presented, and/or when the details of a record accessed in response to a search for the resource request are being viewed.

Following at least one indication of a resource being added to the resource shortlist, an additional search may be performed. At step 930, a modified search may be performed.

The modified search of step 930 may return at least some different results than the search of step 910. The modified search of step 930 may be based on modified search terms submitted by a user, such as a resource manager. Conducting the modified search does not affect the content of the resource shortlist, unless the user specifically makes changes to the resource shortlist. As such, the content of the resource shortlist remains intact unless modified by the user. At step 935, a second subset of the plurality of records may be presented in response to the search of step 930. The presentation of the second subset may be performed similarly to the presentation of the first subset of step 915.

Method 900 continues on FIG. 9B. At step 940, a user selection of one or more records from the second subset is received. When a record is selected for addition to the resource shortlist, an indication of the record may appear on the resource shortlist, such as a name of the resource. As such, these one or more additional indications may be added to the resource shortlist that contains indications of resources from the first subset of the plurality of records. Records related to multiple searches may be added to the same shortlist. As previously detailed, the resource shortlist may be displayed concurrently with the second set of search results (the second subset). If multiple resources are indicated on the resource shortlist, the ordering of resources on the resource shortlist may be based according to: alphabetical order, order in which added to the resource shortlist, or as set by the user. Other orderings are also possible. The user selection that results in indications of one or more additional records to be added to the resource shortlist may be received from the same or a different user than the user that added the initial indications of resources to the resource shortlist.

At step 945, while material relevant to the resource request is being presented to a user, the modified resource shortlist may also be presented. For example, at least as long as the resource request is open, the now modified resource shortlist may be presented when the resource request is being accessed by the user. The resource shortlist may be presented to some or all users that access the resource request. For example, the resource shortlist may be presented to the user that added indications of one or more resources to the resource shortlist and to other users that have not modified the resource shortlist. Having the resource shortlist persist with the resource request results in the resource shortlist being available at other times when the resource request is again accessed. Changes made to the resource shortlist, whether by the user that added indications of one or more resources to the resource shortlist or some other user, may be saved as part of the resource shortlist when the changes were made. The resource shortlist presented at step 945 may be presented when the resource request is accessed, search results pertaining to the resource request are presented, a comparison between resources listed on the resource shortlist is being presented, and/or when the details of a record accessed in response to a search for the resource request are being viewed.

At step 950, a request for a comparison of multiple records indicated on the resource shortlist may be received. Referring to resource shortlist 400 of FIG. 4, a user may select multiple indications of records for comparison. A comparison selector, such as comparison selector 410, may be used to initiate the comparison. At step 955, a comparison of the resource records selected from the resource shortlist may be presented. The comparison may be similar to the comparison presented in FIG. 6. The comparison may be directed to qualifications requested in the resource request. In some embodiments, additional qualifications may also be compared between the resources selected from the resource shortlist for comparison.

At step 960, indications of the records added to the resource shortlist may be linked with the resource request. As such, the resource shortlist, as last modified by a user, may be recalled and presented when the resource request is recalled from storage. For example, a project manager may view the status of a resource request via interface 700 of FIG. 7. The ordering of resources on the resource shortlist may be maintained as ordered by a user. If multiple resource requests are being stored, each of these resource requests may be associated with its own resource shortlist.

At step 965, a user, such as the resource manager, may assign a resource from the resource shortlist to fulfill the resource request. Assignment may occur directly from the resource shortlist. Referring to FIG. 4, an assignment selector of assignment selectors 450 may be used to assign an appropriate resource to fulfill and close the resource request.

FIG. 10 illustrates an embodiment of a computer system. A computer system as illustrated in FIG. 10 may be incorporated as part of the previously described computerized devices. For example, computer system 1000 can represent the resource server system 110, project manager computer system 130, and/or resource manager computer system 120 of FIG. 1. FIG. 10 provides a schematic illustration of one embodiment of a computer system 1000 that can perform the methods provided by various embodiments as described herein. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a mouse, a keyboard, and/or the like; and one or more output devices 1020, which can include without limitation a display device, a printer, and/or the like.

The computer system 1000 may further include (and/or be in communication with) one or more non-transitory storage devices 1025, which can comprise, without limitation, local and/or network accessible storage, and/or can include, without limitation, a disk drive, a drive array, an optical storage device, a solid-state storage device, such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. The communications subsystem 1030 may permit data to be exchanged with a network (such as the network described below, to name one example), other computer systems, and/or any other devices described herein. In many embodiments, the computer system 1000 will further comprise a working memory 1035, which can include a RAM or ROM device, as described above.

The computer system 1000 also can comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1000) to perform methods in accordance with various embodiments of the invention. According to a set of embodiments, some or all of the procedures of such methods are performed by the computer system 1000 in response to processor 1010 executing one or more sequences of one or more instructions (which might be incorporated into the operating system 1040 and/or other code, such as an application program 1045) contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 (and/or components thereof) generally will receive signals, and the bus 1005 then might carry the signals (and/or the data, instructions, etc. carried by the signals) to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

1. A method for maintaining a first listing of candidate resources for a first resource request, the method comprising:
receiving, by a computer system, the first resource request, wherein:
the first resource request specifies a plurality of qualifications requested to be held by a resource assigned to fulfill the first resource request; and
the plurality of qualifications comprises a time period the resource assigned to fulfill the first resource request is requested to be available;
searching, by the computer system, a plurality of resource records using a first set of search criteria to identify a subset of resource records from the plurality of resource records, wherein:
each record of the plurality of resource records indicates qualifications of a corresponding resource; and
each record of the plurality of resource records corresponds to a person;
presenting, by the computer system, the subset of resource records to a user;
receiving, by the computer system, a selection of a plurality of candidate resource records from the subset of resource records;
presenting, by the computer system, a first listing of candidate resources that indicates each candidate resource selected by the user;
storing, by the computer system, the first listing of candidate resources in memory so that the first listing of candidate resources persists;
and
linking, by the computer system, the first listing of candidate resources stored in memory to the first resource request, such that the first listing of candidate resources is presented when the first resource request is again received.

2. The method for maintaining the first listing of candidate resources for the first resource request of claim 1, further comprising:
searching, by the computer system, the plurality of resource records using a second set of search criteria to identify a second subset of resource records, wherein:
the second set of search criteria is different from the first set of search criteria; and
presenting, by the computer system, the first listing of candidate resources such that the first listing of candidate resources is presented concurrently with the second subset of resource records.

3. The method for maintaining the first listing of candidate resources for the first resource request of claim 1, wherein the first listing of candidate resources is displayed concurrently with the subset of resource records.

4. The method for maintaining the first listing of candidate resources for the first resource request of claim 1, further comprising:
receiving, by the computer system, a selection of a candidate resource from the first listing of candidate resources; and
assigning, by the computer system, the candidate resource to the first resource request.

5. The method for maintaining the first listing of candidate resources for the first resource request of claim 1, further comprising:
receiving, by the computer system, a request for a comparison of the candidate resources listed in the first listing of candidate resources; and
presenting, by the computer system, the comparison of the candidate resources.

6. The method for maintaining the first listing of candidate resources for the first resource request of claim 1, further comprising:
determining, by the computer system, a score for each candidate resource that indicates a degree of compliance with the plurality of qualifications of the first resource request.

7. The method for maintaining the first listing of candidate resources for the first resource request of claim 1, further comprising:
receiving, by the computer system, a request from a second user to access a resource request; and
presenting, by the computer system, the first listing of candidate resources to the second user if the resource request is the same as the first resource request.

8. The method for maintaining the first listing of candidate resources for the first resource request of claim 1, wherein modifications of content of the listing of candidate resources are saved without requiring additional user input.

9. A computer program product residing on a non-transitory processor-readable medium for maintaining a first listing of candidate resources for a first resource request, the computer program product comprising processor-readable instructions configured to cause a processor to:
receive the first resource request, wherein:
the first resource request specifies a plurality of qualifications requested to be held by a resource assigned to fulfill the first resource request; and
the plurality of qualifications comprises a time period the resource assigned to fulfill the first resource request is requested to be available;
search a plurality of resource records using a first set of search criteria to identify a subset of resource records from the plurality of resource records, wherein:
each record of the plurality of resource records indicates qualifications of a corresponding resource; and
each record of the plurality of resource records corresponds to a person;
cause the subset of resource records to be presented to a user;
receive a selection of a plurality of candidate resource records from the subset of resource records;
cause the first listing of candidate resources that indicates each candidate resource selected by the user to be presented;
store the first listing of candidate resources in memory so that the first listing of candidate resources persists; and
link the first listing of candidate resources stored in memory to the first resource request, such that the listing of candidate resources is presented when the first resource request is again received.

10. The computer program product of claim 9 further comprising processor-readable instructions configured to cause the processor to:
search the plurality of resource records using a second set of search criteria to identify a second subset of resource records, wherein:
the second set of search criteria is different from the first set of search criteria; and
cause the first listing of candidate resources to be presented such that the first listing of candidate resources is presented concurrently with the second subset of resource records.

11. The computer program product of claim 9, wherein the first listing of candidate resources is displayed concurrently with the subset of resource records.

12. The computer program product of claim 9 comprising processor-readable instructions configured to cause the processor to:
receive a selection of a candidate resource from the first listing of candidate resources; and
assign the candidate resource to the first resource request.

13. The computer program product of claim 9 further comprising processor-readable instructions configured to cause the processor to:
receive a request for a comparison of the candidate resources listed in the first listing of candidate resources; and
cause the comparison of the candidate resources to be presented.

14. The computer program product of claim 9 further comprising processor-readable instructions configured to cause the processor to:
determine a score for each candidate resource that indicates a degree of compliance with the plurality of qualifications of the first resource request.

15. The computer program product of claim 9 further comprising processor-readable instructions configured to cause the processor to:
receive a request from a second user to access a resource request; and
cause the first listing of candidate resources to be presented to the second user if the resource request is the same as the first resource request.

16. The computer program product of claim 9, wherein modifications of content of the listing of candidate resources are saved without requiring additional user input.

17. A system for maintaining a first listing of candidate resources for a first resource request, the system comprising:
a processor; and
a memory communicatively coupled with and readable by the processor and having stored therein processor-readable instructions which, when executed by the processor, cause the processor to:
receive the first resource request, wherein:
the first resource request specifies a plurality of qualifications requested to be held by a resource assigned to fulfill the first resource request; and
the plurality of qualifications comprises a time period the first resource assigned to fulfill the first resource request is requested to be available;
search a plurality of resource records using a first set of search criteria to identify a subset of resource records from the plurality of resource records, wherein:
each record of the plurality of resource records indicates qualifications of a corresponding resource; and
each record of the plurality of resource records corresponds to a person;
cause the subset of resource records to be presented;
receive a selection of a plurality of candidate resource records from the subset of resource records;
cause a first listing of candidate resources that indicates each candidate resource selected to be presented;
store the first listing of candidate resources in the memory so that the first listing of candidate resources persists;
and
link the first listing of candidate resources stored in memory to the first resource request, such that the first listing of candidate resources is presented when the first resource request is again received.

18. The system of claim 17, the processor-readable instructions further configured to cause the processor to:
search the plurality of resource records using a second set of search criteria to identify a second subset of resource records, wherein:
the second set of search criteria is different from the first set of search criteria; and
cause the first listing of candidate resources to be presented such that the first listing of candidate resources is presented concurrently with the second subset of resource records.

19. The system of claim 17, the processor-readable instructions further configured to cause the processor to:
receive a selection of a candidate resource from the first listing of candidate resources; and
assign the candidate resource to the first resource request.

20. The system of claim 17, the processor-readable instructions further configured to cause the processor to:
receive a request for a comparison of the candidate resources listed in the first listing of candidate resources; and
cause the comparison of the candidate resources to be presented.
